(19) United States
(12) Patent Application Publication
(10) Pub. No.: US 2023/0051003 A1
(43) Pub. Date: Feb. 16, 2023

(54) CONTROL APPARATUS, CONTROL METHOD AND PROGRAM

(71) Applicant: NIPPON TELEGRAPH AND TELEPHONE CORPORATION, Tokyo (JP)

(72) Inventors: Koji SUGISONO, Musahino-shi, Tokyo (JP); Shinya KAWANO, Musahino-shi, Tokyo (JP)

(21) Appl. No.: 17/759,201

(22) PCT Filed: Feb. 19, 2020
(86) PCT No.: PCT/JP2020/006475

§ 371 Date: Jul. 21, 2022

(51) Int. Cl. H04L 45/76; H04L 45/42

(52) U.S. Cl. CPC H04L 45/76; H04L 45/42

(57) ABSTRACT

A control apparatus includes a setting unit configured to perform a setting for forwarding a packet destined for first software to a second computer on a switch on a communication path from a first computer to the second computer during a migration of the first software from the first computer to the second computer, the first computer being a computer in which the first software and second software configured to communicate with the first software run, and a deletion unit configured to delete the setting from the switch when the migration of the first software is completed. Thus, the control apparatus shortens the time during which the setting of data forwarding remains at the switch.

### Technical Field

The present invention relates to a control apparatus, a control method and a program.

### Background Art

Stateful network functions such as network address and port translation (NAPT) and firewalls, which use state information (past processing history) for packet processing, are widely used. These packet processing functions, which were previously implemented in hardware, can now be implemented in software (virtualized network function (VNF)) and the software implementation runs on a general-purpose server to deploy functions according to traffic demand. Further, it is now possible to achieve optimization of the forwarding path as the user terminal, the data delivery destination, moves by moving the software implementation to a different server.

On the other hand, there is an increasing number of services, such as virtual reality and augmented reality (AR), that reflect the user's behavior in the virtual space and give the user a new experience through an experience of activities in the virtual space. Such services require that the user's behavior be reflected in the virtual space in a natural way and that the time until the result is displayed on the device used by the user be shortened. To meet this requirement, the network side needs to provide communication that guarantees low latency. There is a method for providing low latency communication when using VNFs, as described in NPTL 1.

In the above cited method, when frequent data communication is performed between VNFs, the VNF functions concerned are run on the same server and data communication is performed via memory. As a result, the data forwarding delay can be reduced compared to the case where the VNF functions concerned are placed in separate servers and data is forwarded over the network.

When VNFs are reallocated, there may be cases where VNFs that perform data communication temporarily operate on different servers although it depends on the timing of completion of the reallocation. In such a case, the data forwarded between the functions will go through the network. In order to forward data over the network, it is necessary to set up a forwarding path for data traffic in the network.

The configured path information is stored in the forwarding table of the switch that performs data forwarding in the network.

In the case of software defined network (SDN) technology such as OpenFlow, a ternary content addressable memory (TCAM) is often used because it allows the use of IDs for identifying many packets compared to conventional IP forwarding. TCAM is characterized by a very short search time for forwarding entries stored in the table, and the search speed can be maintained at a high level even when the number of identification IDs increases. On the other hand, TCAMs have the disadvantages of being expensive, consuming a lot of power, and having a small number of entries in the table. For this reason, a number of methods have been studied to erase unused entries as soon as possible so that the table can be effectively used for other data forwarding.

In the related-art method, it is necessary to explicitly erase entries using a configuration command or a message for configuration, or to automatically erase entries by setting a timeout period, even if the entries are temporarily registered.

### Citation List

Non Patent Literature

NPTL 1X.Zhang, “XenSocket:A High- Throughput Interdomain Transport for Virtual Machines”, ACM/IFIP/USENIX International Conference on Distributed Systems Platforms and Open Distributed Processing.

NPTL 2 OpenFlow Switch Specification Version 1.3.0, [online], the Internet <URL:https://www.opennetworking.org/wp- content/uploads/2014/10/openflow-spec-v1.3.0.pdf>

### SUMMARY OF THE INVENTION

Technical Problem

However, in the case of temporary forwarding path configuration in the case where multiple VNFs are migrated to the same server, there is no method for configuring/erasing paths using configuration commands or configuration messages according to the VNF migration timing. In addition, in the case of automatic deletion of entries by timeout, the timeout that can be set for deleting data forwarding entries is at least one second according to the OpenFlow specification (see NPTL 2, Section A3.4.1), so the entry will remain in the table for a while even after the data forwarding is completed and the entry is no longer needed.

Further, TCAMs are characterized by slow data writing. Therefore, if the TCAM is set up at the timing when a communication line is to be executed, the communication may start before the entry is registered due to the slow writing speed. For example, if a method is used to register a forwarding entry for the next VNF relocation in the TCAM in synchronization with the VNF migration timing, i.e., immediately after the relocation of one VNF is completed, the entry cannot be registered immediately, and packets arriving at the switch will be queued or dropped at the switch.

In consideration of the above-described points, an object of the present invention is to shorten the time during which the setting of data forwarding remains at the switch.

Means for Solving the Problem

To solve the above-mentioned problems, a control apparatus includes a setting unit configured to perform a setting for forwarding a packet destined for a first software to a second computer on a switch on a communication path from a first computer to the second computer during a migration of the first software from the first computer to the second computer, the first computer being a computer in which the first software and a second software configured to communicate with the first software run, and a deletion unit configured to delete the setting from the switch when the migration of the first software is completed.

Effects of the Invention

It is possible to shorten the time during which the setting of data forwarding remains at the switch.

### BRIEF DESCRIPTION OF DRAWINGS

FIG. 1 is a diagram illustrating an example of a configuration of a data forwarding system of a first embodiment.

FIG. 2 is a diagram illustrating an example of a configuration of hardware of a controller 10 according to the first embodiment.

FIG. 3 is a diagram illustrating an example of a functional configuration of a data forwarding system according to the first embodiment.

FIG. 4 is a sequence diagram for describing an example of a processing procedure executed in the data forwarding system according to the first embodiment.

FIG. 5 is a diagram illustrating an example of an update of a forwarding destination table 33 of a certain switch 30 according to the first embodiment.

FIG. 6 is a diagram illustrating an example of a functional configuration of a data forwarding system according to a second embodiment.

FIG. 7 is a sequence diagram for describing an example of a processing procedure executed in the data forwarding system according to the second embodiment. FIG. 8 is a diagram illustrating a first state of the forwarding destination table 33 and a forwarding entry storage table 35 of a certain switch 30 according to the second embodiment.

FIG. 9 is a diagram illustrating a second state of the forwarding destination table 33 and the forwarding entry storage table 35 of a certain switch 30 according to the second embodiment.

FIG. 10 is a diagram illustrating a third state of the forwarding destination table 33 and the forwarding entry storage table 35 of a certain switch 30 according to the second embodiment.

FIG. 11 is a diagram illustrating a fourth state of the forwarding destination table 33 and the forwarding entry storage table 35 of a certain switch 30 according to the second embodiment.

FIG. 12 is a diagram illustrating an example of a functional configuration of a data forwarding system according to a third embodiment.

FIG. 13 is a sequence diagram for describing an example of a processing procedure executed in the data forwarding system according to the third embodiment.

FIG. 14 is a diagram illustrating an example of an update of the forwarding destination table 33 of a certain switch 30 according to the third embodiment.

### Description of Embodiments

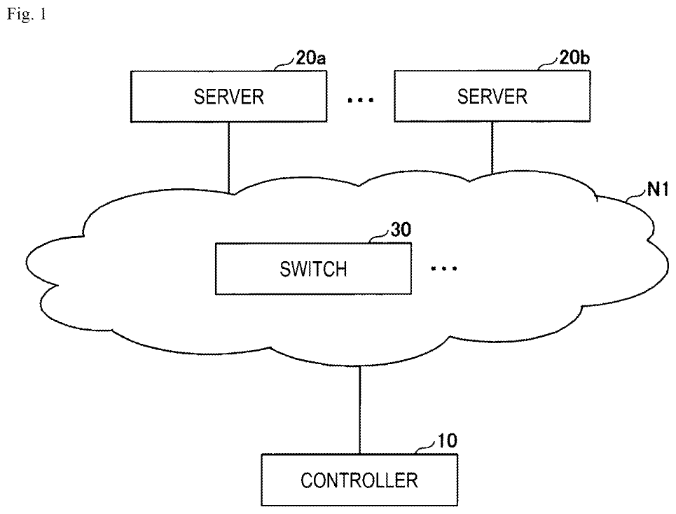

An embodiment of the present invention is described below with reference to the drawings. FIG. 1 is a diagram illustrating an example of a configuration of a data forwarding system of a first embodiment. In the data forwarding system illustrated in FIG. 1, a plurality of servers 20 including a server 20a, a server 20b and the like and a controller 10 are connected to each other through a network N1. The network N1 is a network of a layer 2 including one or more switches 30 (that is, a local area network (LAN)).

The server 20 is a computer where a virtual machine runs. In the present embodiment, a process of software that implements a virtualized network function (VNF) on a virtual machine (hereinafter referred to as simply “VNF”) runs on the server 20. In the present embodiment, any of the VNFs are migrated from a certain server 20 to another server 20. For example, each VNF may be software that executes a packet process.

The controller 10 is a computer that performs, on the switch 30, setting of path information for forwarding a packet destined for the VNF as the migration target to the server 20 as the migration destination in migration of a VNF, and the like.

The switch 30 is a device that forwards packets on the basis of set path information. For example, a software defined network (SDN) switch or the like may be used as the switch 30.

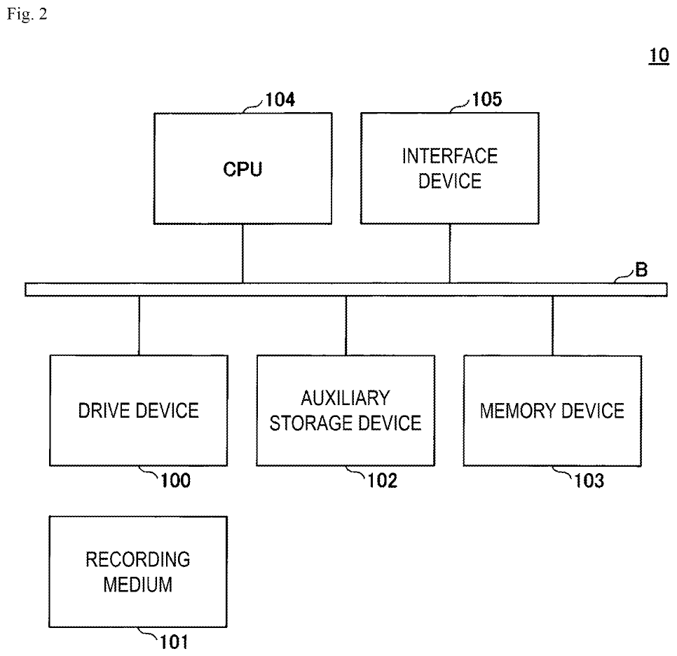

FIG. 2 is a diagram illustrating an example of a configuration of hardware of the controller 10 according to the first embodiment. The controller 10 illustrated in FIG. 2 includes a drive device 100, an auxiliary storage device 102, a memory device 103, a CPU 104, an interface device 105 and the like, which are mutually connected to each other through a bus B.

A program that implements a process at the controller 10 is provided by a recording medium 101 such as a CD-ROM. When the recording medium 101 that stores a program is set to the drive device 100, the program is installed from the recording medium 101 to the auxiliary storage device 102 through the drive device 100. It should be noted that the program need not necessarily be installed using the recording medium 101, and may be downloaded from another computer through a network. The auxiliary storage device 102 stores installed programs, and stores required files, data and the like.

When activation of a program is requested, the memory device 103 reads the program from the auxiliary storage device 102 and stores it. The CPU 104 executes the functions of the controller 10 in accordance with the program stored in the memory device 103. The interface device 105 is used as an interface for connection to the network.

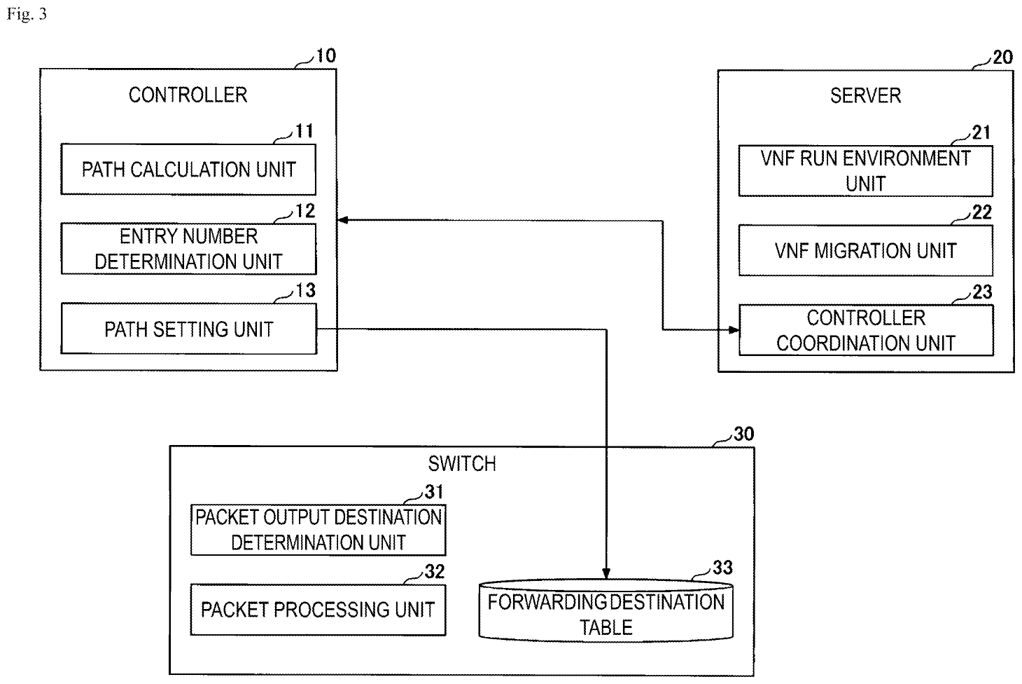

FIG. 3 is a diagram illustrating an example of a functional configuration of a data forwarding system according to the first embodiment. In FIG. 3, the controller 10 includes a path calculation unit 11, an entry number determination unit 12 and a path setting unit 13. Each of the units is implemented through a process in which one or more programs installed in the controller 10 are executed by the CPU 104.

The server 20 includes a VNF run environment unit 21, a VNF migration unit 22 and a controller coordination unit 23. Each of the units is implemented through a process in which one or more programs installed in the server 20 is executed by the CPU of the server 20. Note that the VNF run environment unit 21 is, for example, a hypervisor, and runs a virtualized network function (VNF).

The switch 30 includes a packet output destination determination unit 31, a packet processing unit 32 and the like. Each of the units may be implemented by a process that is executed by the switch 30 under a program installed in the switch 30, or may be implemented by a circuit. The switch 30 further includes a forwarding destination table 33. The forwarding destination table 33 is a table for storing a setting of path information of a packet. For example, the forwarding destination table 33 may be implemented using a ternary content addressable memory (TCAM).

A processing procedure executed in a data forwarding apparatus 1 according to the first embodiment is described below. Note that in the first to third embodiments, four VNFs, the VNF 1 to the VNF 4, that run in the server 20 of the migration source (hereinafter referred to as “migration source server 20a”) are subjected to migration to the server 20 of the migration destination (hereinafter referred to as “migration destination server 20b”). In addition, suppose that communication is performed between the VNF 1 and the VNF 2, between the VNF 2 and the VNF 3, and between the VNF 3 and the VNF 4. As such, it is necessary to perform the migration such that these communications are not affected.

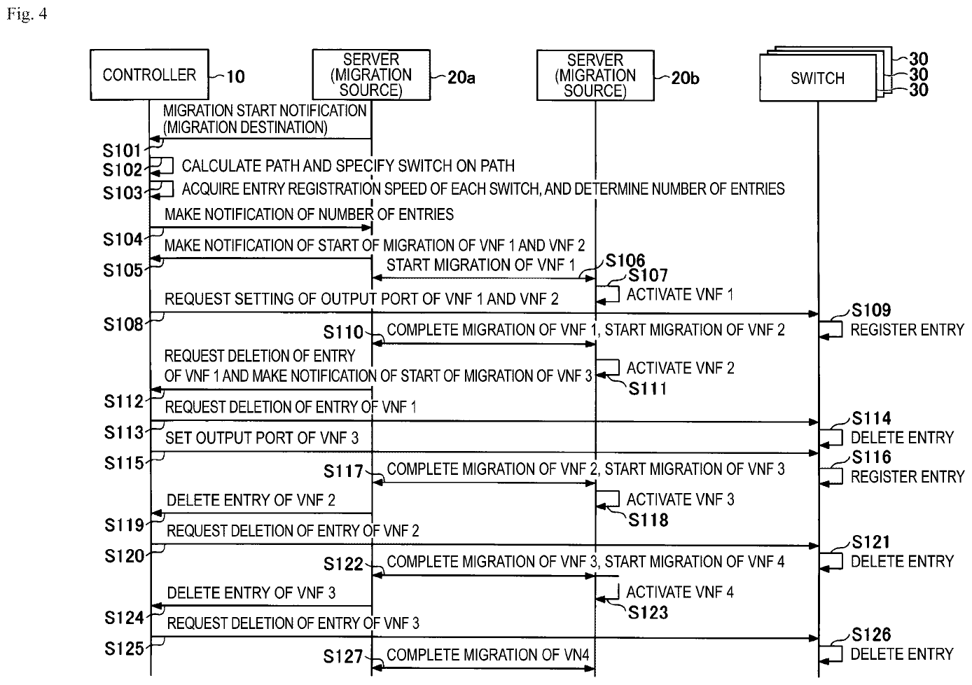

FIG. 4 is a sequence diagram for describing an example of a processing procedure executed in the data forwarding system according to the first embodiment.

At step S101, the controller coordination unit 23 of the migration source server 20a transmits a start notification of the migration including the identification information of the migration destination of the VNF (the migration destination server 20b) to the controller 10.

In response to the start notification, the path calculation unit 11 of the controller 10 calculates the communication path from the migration source server 20a to the migration destination server 20b, and specifies one or more switches 30 (hereinafter referred to as “target switch 30”) on the communication path (S102). Subsequently, the entry number determination unit 12 acquires the registration speed (registration time) per entry to the forwarding destination table 33 of each target switch 30, and determines the number of entries of the forwarding destination table 33 of each target switch 30 on the basis of the set of the registration speeds (S103). Specifically, the number of entries for ensuring that the entry destined for the VNF is registered in each target switch 30 at occurrence of communication destined for the VNF as the migration destination during a migration of a certain VNF is determined. Subsequently, the entry number determination unit 12 notifies the migration source server 20a of the number of entries (S104).

Subsequently, the controller coordination unit 23 notifies the controller 10 of the start of the migration of the VNF corresponding to the number of entries (S105). Here, suppose that the number of entries is 2. Accordingly, a notification of the start of the migration of two VNFs, the VNF 1 and the VNF 2, is made. After this notification, the migration of the VNF 1 is started between the VNF migration unit 22 of the migration source server 20a and the VNF migration unit 22 of the migration destination server 20b (S106). Along with the start of the migration, the VNF run environment unit 21 of the migration destination server 20b activates the VNF 1 as the migration target. That is, at this point of time, a state where the VNF 1 is activated in both the migration source server 20a and the migration destination server 20b is set.

On the other hand, in response to the notification of the start of the migration (S105), the path setting unit 13 of the controller 10 makes a request of setting the output port of the packet destined for the VNF 1 and the VNF 2, to each target switch 30 (S108). That is, a setting of path information for forwarding the packet destined for the VNF 1 and the VNF 2 to the migration destination server 20b is requested to each target switch 30. As a result, the entry corresponding to each of the VNF 1 and the VNF 2 is registered in the forwarding destination table 33 of each target switch 30 (S109).

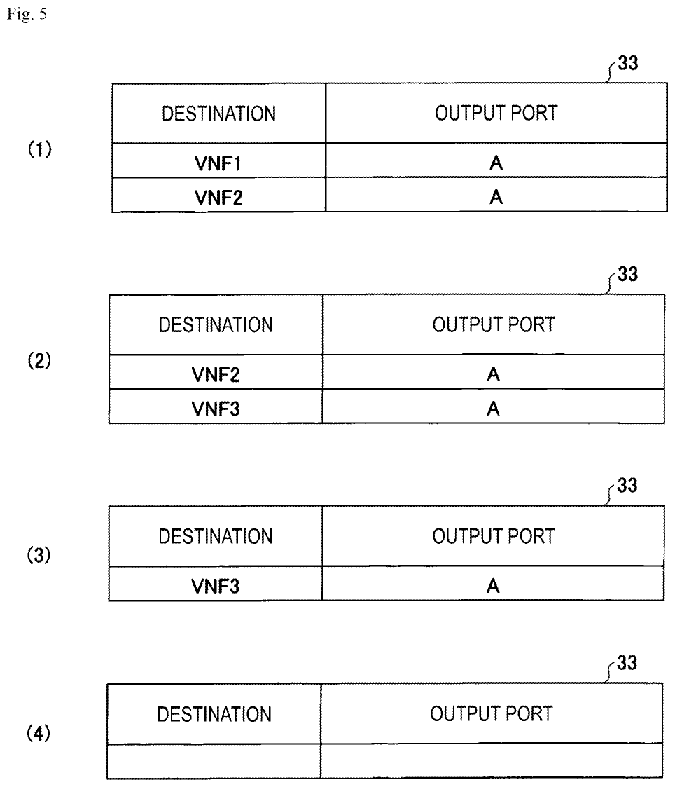

FIG. 5 is a diagram illustrating an example of an update of the forwarding destination table 33 of a certain switch 30 according to the first embodiment. After the execution of step S109, the forwarding destination table 33 of a certain target switch 30 is set to a state illustrated in (1). In (1), the entry of the VNF 1 and the entry of the VNF 2 (path information) are registered in the forwarding destination table 33. An example of a setting in which, in each entry, the packet destined for the corresponding VNF is output from an output port A. Note that FIG. 5 illustrates an example in which the output port A is a port corresponding to the path to the migration destination server 20b in the target switch 30.

Thereafter, the VNF 1 in the migration source server 20a is stopped at an appropriate timing. In this state, when receiving the packet destined for the VNF 1 of the migration destination server 20b that is transmitted from the VNF 2 of the migration source server 20a, the packet output destination determination unit 31 of each target switch 30 determines the port of the output destination of the packet on the basis of the forwarding destination table 33. The packet processing unit 32 outputs the packet from the port determined by the packet output destination determination unit 31. In the example illustrated in FIG. 5, the packet is output from the port A. As a result, the packet is forwarded to the VNF 1 of the migration destination server 20b.

When the migration of the VNF 1 is completed, the migration of the VNF 2 is started

(S110). Along with the start of the migration of the VNF 2, the VNF run environment unit 21 of the migration destination server 20b activates the VNF 2 (S111). That is, at this point of time, a state where the VNF 2 is activated in both the migration source server 20a and the migration destination server 20b is set.

Subsequently, the controller coordination unit 23 of the migration source server 20a transmits a deletion request of the entry of the VNF 1 and a migration start notification of the VNF 3 to the controller 10 (S112). Subsequently, the path setting unit 13 of the controller 10 transmits a deletion request of the entry of the VNF 1 to each target switch 30 (S113). In response to the deletion request, each target switch 30 deletes the entry to the VNF 1 from the forwarding destination table 33 (S114). The reason for this is that the entry is unnecessary because the VNF 2 is already activated in the migration destination server 20b, and the communication between the VNF 2 and the VNF 1 in the migration destination server 20b is enabled (that is, it does not go via each target switch 30).

Subsequently, the path setting unit 13 of the controller 10 makes a request of setting the output port of the packet destined for the VNF 3 to each target switch 30 (S115). As a result, the entry corresponding to the VNF 3 is registered in the forwarding destination table 33 of each target switch 30 (S116). At this time point, as illustrated in (2) of FIG. 5, the forwarding destination table 33 of each target switch 30 is in a state where the output port corresponding to each of the destinations of the VNF 2 and the VNF 3 is registered.

Thereafter, the VNF 2 of the migration source server 20a is stopped at an appropriate timing. In this state, when receiving the packet destined for the VNF 2 of the migration destination server 20b that is transmitted from the VNF 3 of the migration source server 20a, each target switch 30 determines the port of the output destination of the packet on the basis of the forwarding destination table 33. The packet processing unit 32 outputs the packet from the port determined by the packet output destination determination unit 31. In the example illustrated in FIG. 5, the packet is output from the port A. As a result, the packet is forwarded to the VNF 2 of the migration destination server 20b.

When the migration of the VNF 2 is completed, the migration of the VNF 3 is started (S117). Along with the start of the migration of the VNF 3, the VNF run environment unit 21 of the migration destination server 20b activates the VNF 3 (S118). That is, at this point of time, a state where the VNF 3 is activated in both the migration source server 20a and the migration destination server 20b is set.

Subsequently, the controller coordination unit 23 of the migration source server 20a transmits a deletion request of the entry of the VNF 2 to the controller 10 (S119). Subsequently, the path setting unit 13 of the controller 10 transmits a deletion request of the entry of the VNF 2 to each target switch 30 (S120). In response to the deletion request, each target switch 30 deletes the entry to the VNF 2 from the forwarding destination table 33 (S121). At this time point, as illustrated in (3) of FIG. 5, the forwarding destination table 33 of each target switch 30 is in a state where the output port corresponding to the destination of the VNF 3 is registered.

Thereafter, the VNF 3 in the migration source server 20a is stopped at an appropriate timing. In this state, when receiving the packet destined for the VNF 3 of the migration destination server 20b that is transmitted from the VNF 4 of the migration source server 20a, the packet output destination determination unit 31 of each target switch 30 determines the port of the output destination of the packet on the basis of the forwarding destination table 33. The packet processing unit 32 outputs the packet from the port determined by the packet output destination determination unit 31. In the example illustrated in FIG. 5, the packet is output from the port A. As a result, the packet is forwarded to the VNF 3 of the migration destination server 20b.

When the migration of the VNF 3 is completed, the migration of the VNF 4 is started

(S123). Along with the start of the migration of the VNF 4, the VNF run environment unit 21 of the migration destination server 20b activates the VNF 4 (S118). That is, at this point of time, a state where the VNF 4 is activated in both the migration source server 20a and the migration destination server 20b is set.

Subsequently, the controller coordination unit 23 of the migration source server 20a transmits a deletion request of the entry of the VNF 3 to the controller 10 (S124). Subsequently, the path setting unit 13 of the controller 10 transmits the deletion request of the entry of the VNF 3 to each target switch 30 (S125). In response to the deletion request, each target switch 30 deletes the entry to the VNF 3 from the forwarding destination table 33 (S126). At this time point, in the forwarding destination table 33 of each target switch 30, no entry destined for any VNF is registered as illustrated in (4) of FIG. 5.

Thereafter, the migration of the VNF 4 is completed (S127). Note that since the traffic destined for the VNF 4 is a path different from the communication path configured by the target switch 30, it is not necessary to register the entry corresponding to that traffic, for the target switch 30.

As described above, according to the first embodiment, an entry destined for a VNF in the forwarding destination table 33 is deleted immediately after the completion of the migration of the VNF. Thus, the time during which the setting (entry) of data forwarding remains at the switch 30 (the forwarding destination table 33) can be shortened. As a result, the forwarding destination table 33 can be effectively utilized.

Next, a second embodiment is described. In the second embodiment, differences from the first embodiment are described. The points that are not described in the second embodiment may be the same as those of the first embodiment.

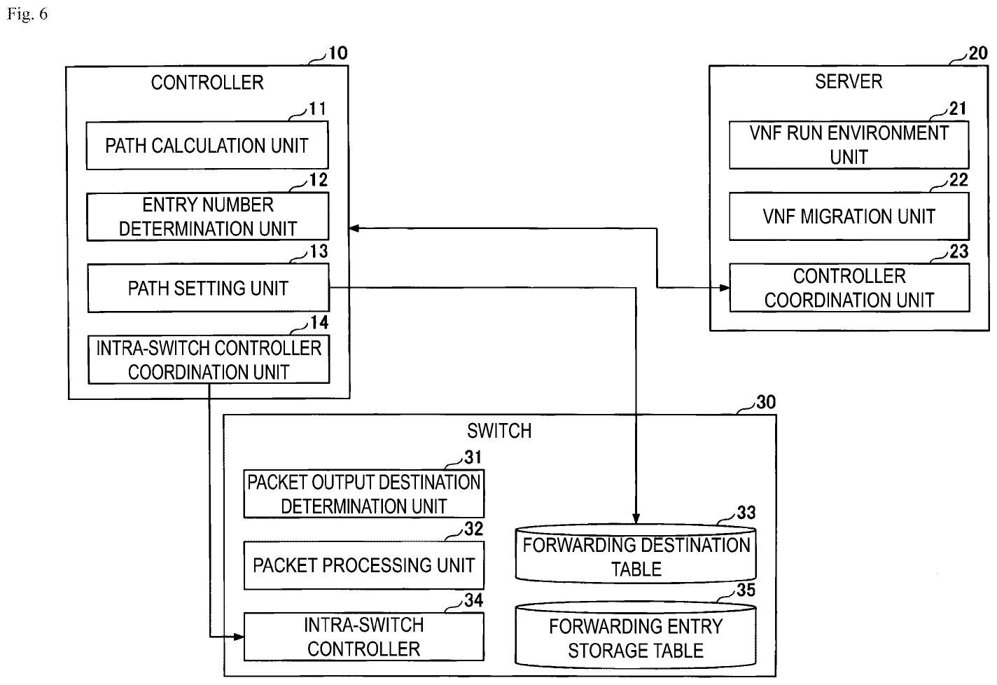

FIG. 6 is a diagram illustrating an example of a functional configuration of a data forwarding system according to the second embodiment. In FIG. 6, portions identical to or corresponding to those of FIG. 3 are denoted with the same reference numerals, and the description thereof will be omitted.

In FIG. 6, the switch 30 further includes an intra-switch controller 34 and a forwarding entry storage table 35. The intra-switch controller 34 can be implemented using the circuit or the CPU of the switch 30. The forwarding entry storage table 35 can be implemented using the memory of the switch 30.

The controller 10 further includes an intra-switch controller coordination unit 14. The intra-switch controller coordination unit 14 can be implemented through a process that is executed by the CPU 104 under a program installed in the controller 10.

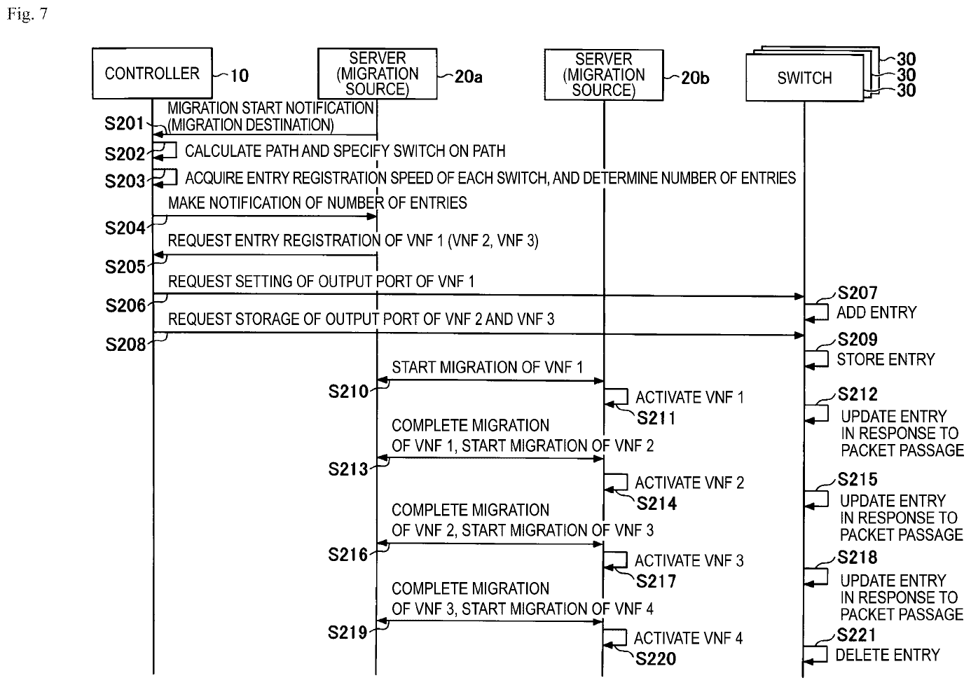

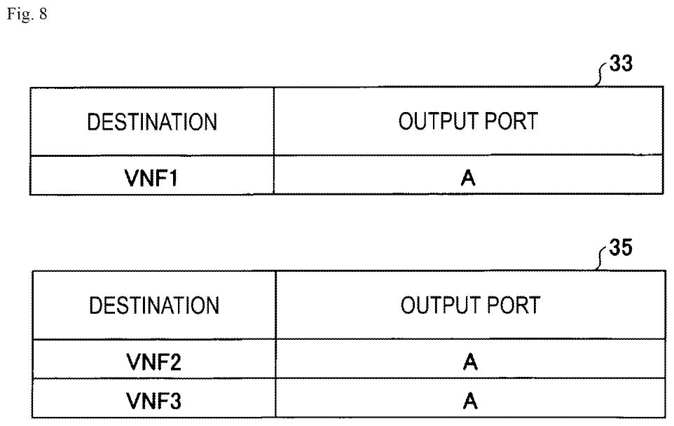

FIG. 7 is a sequence diagram for describing an example of a processing procedure executed in the data forwarding system according to the second embodiment. Steps S201 to S204 are the same as steps S101 to S104 of FIG. 4.

Subsequently to step S204, the controller coordination unit 23 of the migration source server 20a transmits, to the controller 10, a registration request of the entry of the VNF 1, and a registration request to the intra-switch controller 34 of each VNF to be migrated subsequent to the VNF 1 (in the example illustrated in FIG. 7, the VNF 2 and the VNF 3), corresponding to the number of entries notified at step S204 (S205).

Subsequently, the path setting unit 13 of the controller 10 makes a request of setting the output port of the packet destined for the VNF 1 to each target switch 30 (S206). As a result, the entry corresponding to the VNF 1 is registered in the forwarding destination table 33 of each target switch 30 (S207).

Subsequently, the intra-switch controller coordination unit 14 transmits a storage request of setting the output port destined for each of the VNF 2 and the VNF 3 to the intra-switch controller 34 of each target switch 30 (S208). The storage request is a request for registering the entry of the VNF 2 in the forwarding destination table 33 in response to a passage of the packet destined for the VNF 1. The intra-switch controller 34 of each target switch 30 registers the entries corresponding to the VNF 2 and the VNF 3 in the forwarding entry storage table 35 (S209).

FIG. 8 is a diagram illustrating a first state of the forwarding destination table 33 and the forwarding entry storage table 35 of a certain switch 30 according to the second embodiment. As illustrated in FIG. 8, at the time point of step S209, the entry destined for the VNF 1 is registered in the forwarding destination table 33. On the other hand, the entries corresponding to the VNF 2 and the VNF 3 are registered in the forwarding entry storage table 35.

Subsequently, when the migration of the VNF 1 is started between the VNF migration unit 22 of the migration source server 20a and the VNF migration unit 22 of the migration destination server 20b (S210), the VNF run environment unit 21 of the migration destination server 20b activates the VNF 1 (S211).

In this state, when the packet output destination determination unit 31 of each target switch 30 makes a next entry request to the intra-switch controller 34 of the switch 30 in response to a passage of the packet destined for the VNF 1 through each target switch 30, the intra-switch controller 34 registers, in the forwarding destination table 33, the first entry (in the example illustrated in FIG. 8, the entry of the VNF 2) of the entries registered in the forwarding entry storage table 35 (S212).

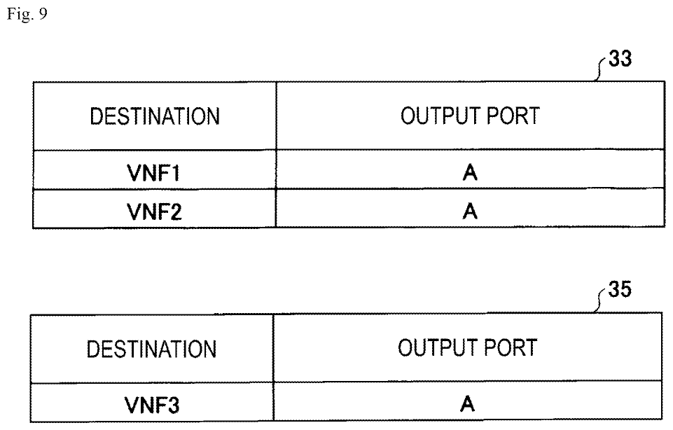

FIG. 9 is a diagram illustrating a second state of the forwarding destination table 33 and the forwarding entry storage table 35 of a certain switch 30 according to the second embodiment. After the execution of step S212, the entry of the VNF 2 registered in the forwarding entry storage table 35 is registered in the forwarding destination table 33.

When the migration of the VNF 1 is completed, the migration of the VNF 2 is started (S213). Along with the start of the migration of the VNF 2, the VNF run environment unit 21 of the migration destination server 20b activates the VNF 2 (S214).

In this state, when the packet output destination determination unit 31 of each target switch 30 makes a next entry request to the intra-switch controller 34 of the switch 30 in response to a passage of the packet destined for the VNF 2 through each target switch 30, the intra-switch controller 34 deletes the entry of the VNF 1 from the forwarding destination table 33, and registers, in the forwarding destination table 33, the first entry (in the example illustrated in FIG. 9, the entry of the VNF 3) of the entries registered in the forwarding entry storage table 35 (S215).

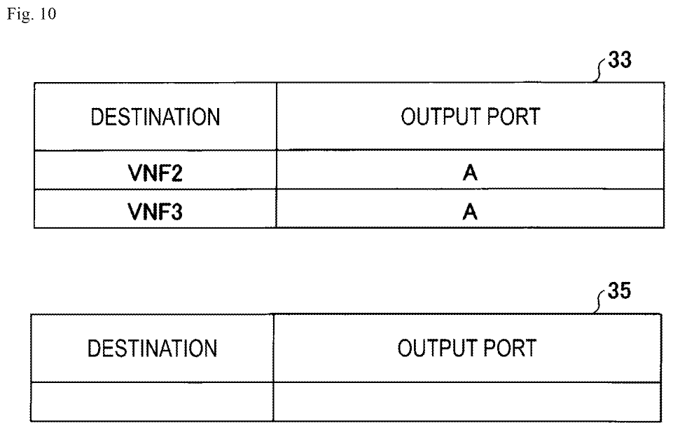

FIG. 10 is a diagram illustrating a third state of the forwarding destination table 33 and the forwarding entry storage table 35 of a certain switch 30 according to the second embodiment. As illustrated in FIG. 10, after the execution of step S215, the entry of the VNF 2 and the entry of the VNF 3 are registered in the forwarding destination table 33. On the other hand, the forwarding entry storage table 35 is emptied.

When the migration of the VNF 2 is completed, the migration of the VNF 3 is started (S216). Along with the start of the migration of the VNF 23, the VNF run environment unit 21 of the migration destination server 20b activates the VNF 3 (S217).

In this state, when the packet output destination determination unit 31 of each target switch 30 makes a next entry request to the intra-switch controller 34 of the switch 30 in response to a passage of the packet destined for the VNF 3 through each target switch 30, the intra-switch controller 34 deletes the entry of VNF 2 from the forwarding destination table 33 (S218). It should be noted that, since the forwarding entry storage table 35 is already empty, new entry is not registered in the forwarding destination table 33.

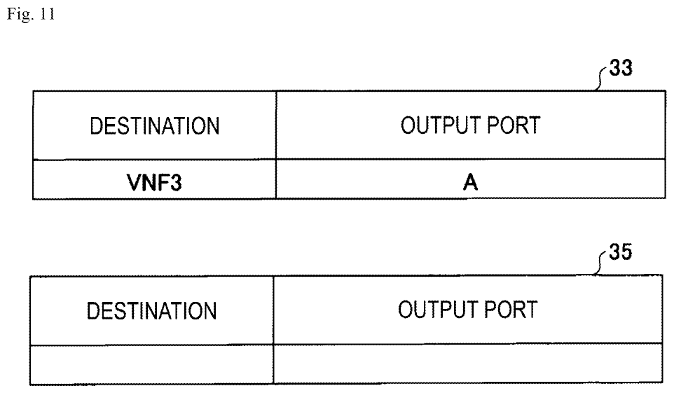

FIG. 11 is a diagram illustrating a fourth state of the forwarding destination table 33 and the forwarding entry storage table 35 of a certain switch 30 according to the second embodiment. As illustrated in FIG. 11, after the execution of step S218, only the entry of the VNF 3 is registered in the forwarding destination table 33.

Thereafter, when the migration of the VNF 3 is completed, the migration of the VNF 4 is started (S219). Along with the start of the migration of the VNF 2, the VNF run environment unit 21 of the migration destination server 20b activates the VNF 4 (S220).

As a result, the packet destined for the VNF 3 does not pass at each target switch 30. Therefore, when a time-out of the entry of the VNF 3 occurs at each target switch 30 and/or a request of the deletion of the entry is made through the controller 10, the packet output destination determination unit 31 of each target switch 30 deletes the entry of the VNF 3 from the forwarding destination table 33 (S221). As a result, the forwarding destination table 33 is emptied.

In this manner, the second embodiment can provide the same effects as those the first embodiment.

Next, a third embodiment is described. In the third embodiment, differences from the first embodiment are described. The points that are not described in the third embodiment may be the same as those of the first embodiment.

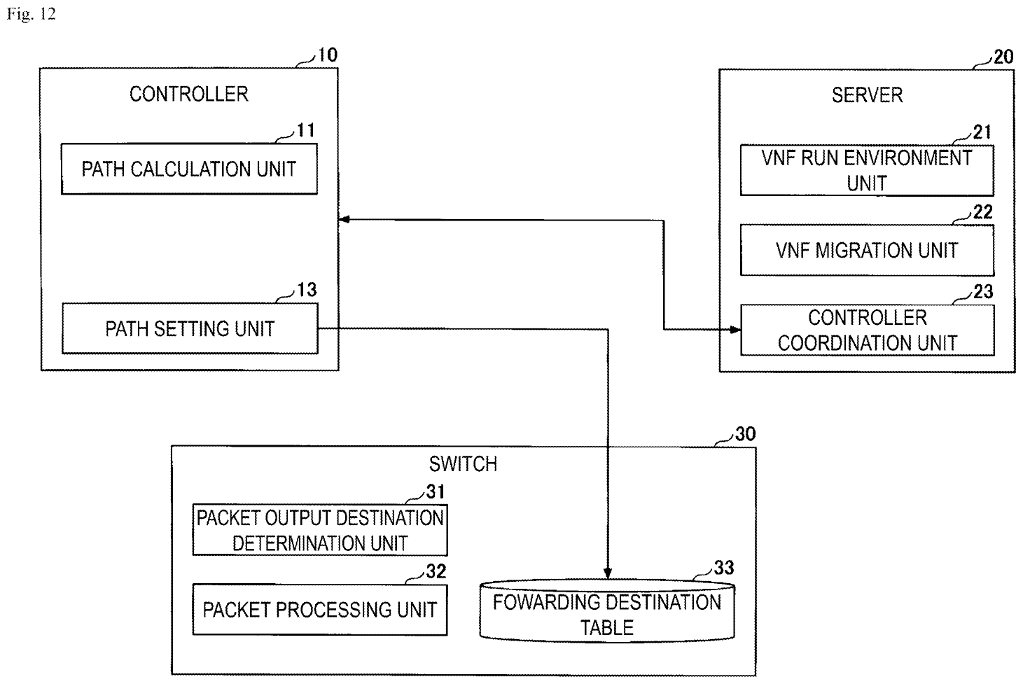

FIG. 12 is a diagram illustrating an example of a functional configuration of the data forwarding system according to the third embodiment. In FIG. 12, the portions identical to or corresponding to those of FIG. 3 are denoted with the same reference numerals, and the description thereof will be omitted. As illustrated in FIG. 12, in the third embodiment, the controller 10 need not include the entry number determination unit 12.

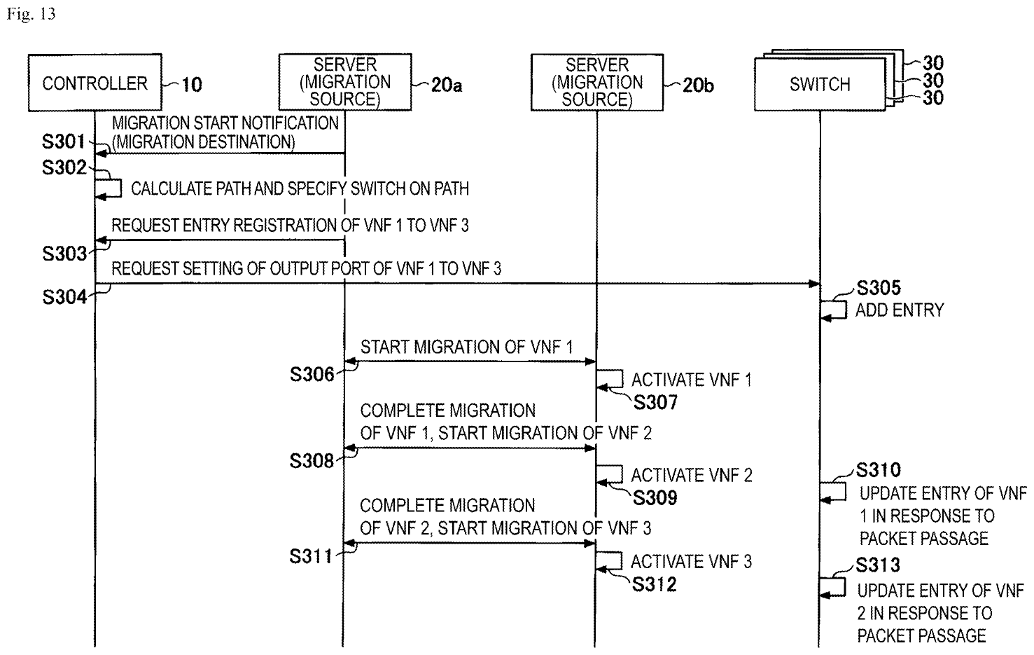

FIG. 13 is a sequence diagram for describing an example of a processing procedure executed in the data forwarding system according to the third embodiment. In FIG. 13, steps S301 and S302 are the same as steps S101 and S102 of FIG. 4.

At step S303, the controller coordination unit 23 of the migration source server 20a transmits a registration request of the entry of each of the VNF 1, the VNF 2 and the VNF 3 to the controller 10.

Subsequently, the path setting unit 13 of the controller 10 makes a request of setting the output port of the packet destined for each of the VNF 1, the VNF 2 and the VNF 3, to each target switch 30 (S304). As a result, the entry corresponding to each of the VNF 1, the VNF 2 and the VNF 3 is registered in the forwarding destination table 33 of each target switch 30 (S305).

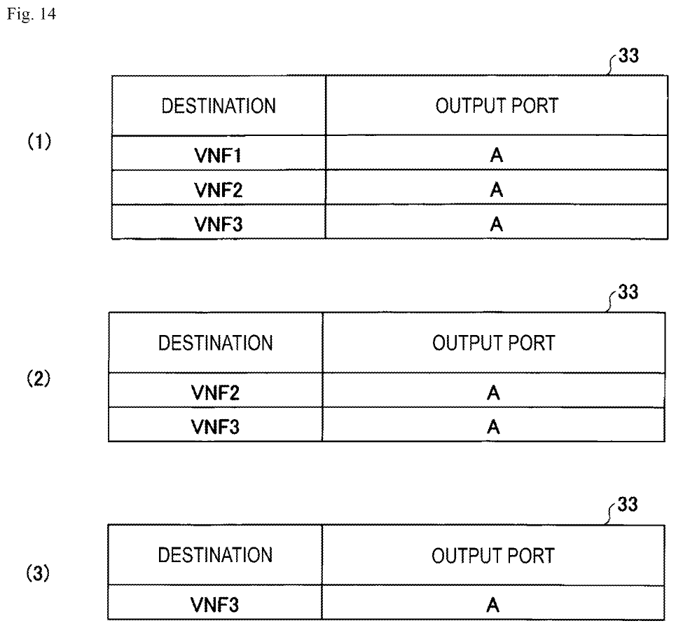

FIG. 14 is a diagram illustrating an example of an update of the forwarding destination table 33 of a certain switch 30 according to the third embodiment. After the execution of step S305, the forwarding destination table 33 of a certain target switch 30 is set to a state illustrated in (1). In (1), the entry of the VNF 1, the entry of the VNF 2 and the entry of the VNF 3 are registered in the forwarding destination table 33. An example of a setting in which, in each entry, the packet destined for the corresponding VNF is output from an output port A. Note that FIG. 14 illustrates an example in which the output port A is a port corresponding to the communication path to the migration destination server 20b at the target switch 30.

Subsequently, when the migration of the VNF 1 is started between the VNF migration unit 22 of the migration source server 20a and the VNF migration unit 22 of the migration destination server 20b (S306), the VNF run environment unit 21 of the migration destination server 20b activates the VNF 1 (S307).

In this state, the packet destined for the VNF 1 arrives at each target switch 30 first, and therefore the packet processing unit 32 of each target switch 30 outputs the packet from the output port set to the forwarding destination table 33 (in the example illustrated in FIG. 14, the port A).

When the migration of the VNF 1 is completed, the migration of the VNF 2 is started (S308). Along with the start of the migration of the VNF 2, the VNF run environment unit 21 of the migration destination server 20b activates the VNF 2 (S309).

In this state, in response to the arrival of the packet destined for the VNF 2 at each target switch 30, the packet output destination determination unit 31 of each target switch 30 deletes the entry of the VNF 1 from the forwarding destination table 33 (S310). Accordingly, the forwarding destination table 33 is set to the state illustrated in (2) of FIG. 14.

When the migration of the VNF 2 is completed, the migration of the VNF 3 is started (S311). Along with the start of the migration of the VNF 3, the VNF run environment unit 21 of the migration destination server 20b activates the VNF 3 (S312).

In this state, in response to the arrival of the packet destined for the VNF 3 at each target switch 30, the packet output destination determination unit 31 of each target switch 30 deletes the entry of the VNF 2 from the forwarding destination table 33 (S313). Accordingly, the forwarding destination table 33 is set to the state illustrated in (3) of FIG. 14.

As described above, the third embodiment can provide the same effects as those the first embodiment.

Note that in the above-mentioned embodiments, the controller 10 is an example of a control apparatus. The migration source server 20a is an example of a first computer. The migration destination server 20b is an example of a second computer. The VNF 1 is an example of first software. The VNF 2 is an example of second software. The path setting unit 13 is an example of a setting unit and a deletion unit. The intra-switch controller coordination unit 14 is an example of a transmission unit.

While embodiments of the present invention are described above, the invention is not limited to the specific embodiment, and various modification and alterations may be made within the scope of the gist of the invention as described in the claims.

### Reference Signs List

10 Controller

11 Path calculation unit

12 Entry number determination unit

13 Path setting unit

14 Intra-switch controller coordination unit

20 Server

21 VNF run environment unit

22 VNF migration unit

23 Controller coordination unit

30 Switch

31 Packet output destination determination unit

32 Packet processing unit

33 Forwarding destination table

34 Intra-switch controller

35 Forwarding entry storage table

100 Drive device

101 Recording medium

102 Auxiliary storage device

103 Memory device

104 CPU

105 Interface device

B Bus

1. A control apparatus comprising:
a processor: and
a memory storing program instructions that cause the processor to:
perform a setting for forwarding a packet destined for first software to a second computer on a switch on a communication path from a first computer to the second computer during a migration of the first software from the first computer to the second computer, the first computer being a computer in which the first software and second software configured to communicate with the first software run; and
delete the setting from the switch after the migration of the first software is completed.

2. A control apparatus comprising:
a processor; and
a memory storing program instructions that cause the processor to:
perform a setting for forwarding, to a second computer, a packet destined for first software to be migrated from a first computer to the second computer, on a switch on a communication path from the first computer to the second computer; and
transmit, to the switch, a request for causing the switch to execute a setting for forwarding a packet destined for second software to the second computer in response to a passage of a packet destined for the first software, the second software being migrated from the first computer to the second computer after a migration of the first software and being configured to communicate with the first software.

3. The control apparatus according to claim 1,
wherein when a packet destined for the second software arrives after the first software is migrated to the second computer, the processor causes the switch to delete the setting.

4. A control method at a computer, comprising:
performing a setting for forwarding a packet destined for first software to a second computer on a switch on a communication path from a first computer to the second computer during a migration of the first software from the first computer to the second computer, the first computer being a computer in which the first software and second software configured to communicate with the first software run; and
deleting the setting from the switch after the migration of the first software is completed. S. (Canceled)

6. The control method according to claim 4,
wherein the deleting, of the setting is performed when the packet destined for the second software arrives after the first software is migrated to the second computer.

7. A non-transitory computer-readable recording medium having stored therein a program for causing a computer to execute the control method according to claim 4.
